(19) United States
(12) Patent Application Publication
(10) Pub. No.: US 2008/0063389 A1
(43) Pub. Date: Mar. 13, 2008

(54) Tracking a Focus Point by a Remote Camera

(75) Inventors: Zheng Fang, Round Lake, IL (US); Yucheng Jin, Chalfont, PA (US)

Correspondence Address: Motorola, Inc.;Law Department, 1303 East Algonquin Road, 3rd Floor, Schaumburg, IL, 60196, US

(73) Assignee: General Instrument Corporation, Horsham, PA (US)

(21) Appl. No.: 11/531,402

(22) Filed: Sep. 13, 2006

(51) Int. Cl. G03B 17/00

(52) U.S. Cl. 396/56

(57) ABSTRACT

A remote unit comprises a camera, which may be controlled with input received from a local unit. The input may include the selection of a focus point, which the remote camera may use to lock onto the focus point. The remote camera may atomically track movement of the focus point and transmit captured images of the focus point.

### BACKGROUND

Cameras are commonly used in various networking applications, such as internet protocol (IP) video phones and other forms of video conferencing. Cameras allow a user to view, often in real-time, remote participants to a conference. One such example includes IP video phones, which have multi-part viewing areas on each phone's display screen. One part of the viewing area displays the remote call participants while another part of the viewing area displays the local user of the phone. Based on the latter display, the local user of the phone may adjust her local camera or her body position to provide the remote participants with different views of the local user.

In a natural face-to-face conversation, an individual's view focuses on different areas of other participants and the individual often changes the point of focus repeatedly throughout a conversation. For example, the individual may focus on a speaker's eyes and then change the point of focus to an object that the speaker may be holding or an object in the room that is the subject of the conversation. Similarly, the individual may need to alter the point of focus as the speaker moves around during a natural conversation. However, conventional video conferencing systems do not accurately simulate a natural face-to-face conversation because a local user has no control on the viewing area of the remote camera capturing images of the remote party. The local user lacks the ability to control the remote camera by changing the viewing angle or zooming in or out of the remote frame to see different views of remote participants.

### BRIEF DESCRIPTION OF THE DRAWINGS

Various features of the embodiments can be more fully appreciated, as the same become better understood with reference to the following detailed description of the embodiments when considered in connection with the accompanying figures.

FIG. 1 illustrates a video conferencing system;

FIG. 2 illustrates a block diagram of a remote unit;

FIG. 3 illustrates a flow chart of a method tracking a focus point;

FIG. 4 illustrate a flow chart of a method for locking onto a second focus point; and

FIG. 5 illustrates a block diagram of a computing platform.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

A method and system described herein allows for the simulation of a natural face-to-face conservation. The method and system may include a videoconferencing system having a remote camera. A videoconferencing system, in its simplest form, may comprise a system having a remote unit with a remote camera capturing and transmitting video to a local unit, which displays the video captured by the remote unit. A videoconferencing system may also include other features such as integrated audio and interactive tools allowing a local user to enter input. For example, a local user may control the remote camera by choosing a focus point within the field of view of the remote camera. The camera may use a pattern recognition module to lock onto the chosen focus point. The camera may also utilize a tracking module to follow the motion of the chosen focus point. The method and system allows a local user to quickly change focus points such that the remote camera locks onto and follows new focus points at the local user's discretion. Therefore, this level of control over the remote camera simulates a natural face-to-face conversation.

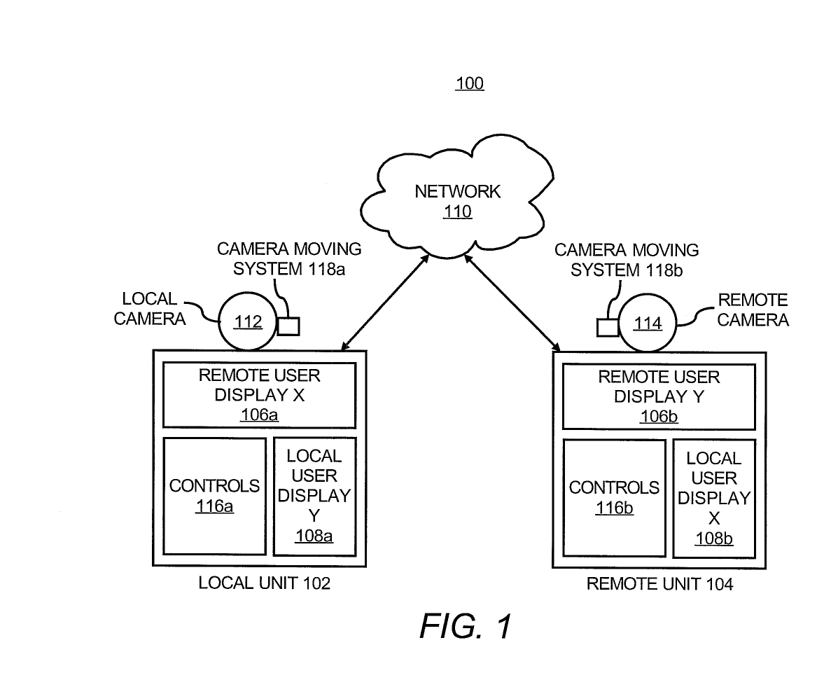

FIG. 1 depicts an illustrative videoconferencing system 100. The videoconferencing system 100 includes a local unit 102 and a remote unit 104, which may communicate through a network 110. The local unit 102 may, in its simplest form, be a display screen capable of displaying images received over the network 110. The local unit 102 may comprise any videoconferencing system, such as an IP video phone, an instant messaging application, other conferencing systems, etc. The local unit 102 may be self contained unit, such as a video phone in either tablet or hand-held form, or the local unit 102 may be integrated into a computer or other system, such as a personal computer with an external or internal camera. The local unit 102 depicted in FIG. 1, as an example, has a local user display 108a, a remote user display 106a, controls 116a, a local camera 112, and a camera moving system 118a.

It should be noted that the configuration of the local unit 102 depicted in FIG. 1 is merely an example of some of the elements that may be included in the local unit 102 and the local unit 102 may lack some of the elements depicted in FIG. 1 or may include other elements not depicted in FIG. 1. For example, the local unit 102 may include an internal or external microphone or any other method of capturing and transmitting audio data. Similarly, FIG. 1 depicts only an example of the configuration and arrangement of the elements of the local unit 102 and the skilled artisan will understand that the elements of the local unit 102 may be arranged in any configuration.

The local camera 112 may be a video camera, which captures video of the local user, depicted herein as “Y.” The images captured by the local camera 112 may be displayed on the local user display 108a. Thus, the local user Y may view the images captured by the local camera 112 and adjust her position or the position of the local camera 112 to alter the view captured by the local camera 112. FIG. 1 illustrates an embodiment where only one camera is used in each of the local unit 102 and the remote unit 104. However, other embodiments may include the use of two or more cameras in either the local unit 102 or the remote unit 104.

The camera moving system 118a may be a component or group of components having the ability to move, or otherwise alter the viewing position of the local camera 112. For example, the camera moving system 118a may comprise a motor, an actuator, magnetic components, etc. The camera moving system 118a may move the entire local camera 112 by, for example, rotating, sliding, elevating, descending, or the camera moving system 118a may move only a component of the local camera 112, such as the lens or other optical component.

The controls 116a may include any controls for controlling the function of the local unit 102 and/or displaying information pertaining to the local unit 102, the remote unit 104, or the network 110. The controls 116a may include a graphical user interface for receiving user input and providing feedback to the user. For examples, the controls 116a may allow a user to control the local camera 112 and/or the remote camera 114. The controls 116a may display information about the audio and video levels of the conferencing system or information about the participants to the conference. The controls 116a may also include interactive tools and displays allowing a user to communicate with other participants to the conference through the input and/or display of text.

A user may provide input into either the local unit 102 or the remote unit 104 through the controls 116a or 116b by any manner. For example, the controls 116a or 116b may provide interactive tools for selecting a focus point, zoom in and out functions, directional arrow keys, etc. that a local user Y may select with a mouse, keyboard, joystick, etc. The controls 116a or 116b may utilize touch-screen technology so that a user may directly touch the controls 116a or 116b to provide input. The controls 116a or 116b may also respond to voice commands from a user.

Images captured by the local camera 112 may be transmitted through the network 110 to the remote unit 104. The network 110 may be any method of connecting and allowing the transfer of data between the local unit 102 and the remote unit 104, such as the Internet, an intranet connection, a Local Area network, a Wide Area network, a Personal Area Network, wired, wireless, etc.

The remote unit 104, in its simplest form, may include a remote camera 114 and the ability to transmit images captured by the remote camera 114 over the network 110. The example depicted in FIG. 1 depicts a remote unit 104 having a remote user display 106b, a local user display 108b, and controls 116b. The images captured by the local camera 112, such as images of the local user Y, may be displayed on the remote user display 106b of the remote unit 104. As with the local unit 102, the remote unit 104 may include a camera moving system 118b and remote camera 114, capturing video images, such as video images of the remote user, hereafter “X,” for display on the local user display 108b of the remote unit 104. The images captured by the remote camera 114 may be transmitted through the network 110 to be displayed on the remote user display 106a of the local unit 102. Therefore, in the example depicted in FIG. 1, each user may view the images captured by their own cameras and the images captured by the other user's camera.

Both the local camera 112 and the remote camera 114 may capture one or more of low resolution video, low resolution still images, high resolution video, and high resolution still images. One or both cameras may include a number of components known in the art, but not depicted in FIG. 1, such as, for example, image capturing components, flashes or other light sources, and memory for storing images.

The configuration of the remote unit 104 depicted in FIG. 1 is merely an example of some of the elements that may be included in the remote unit 104 and the remote unit 104 may lack some elements depicted in FIG. 1 or may include other elements not depicted in FIG. 1. For example, the remote unit 102 may include an internal or external microphone or any other method of capturing and transmitting audio. Similarly, FIG. 1 depicts only an example of the configuration and arrangement of the elements of the remote unit 104 and the elements of the remote unit 104 may be arranged in any configuration or arrangement. The remote unit 104 may be similar to the local unit 102 or may be different from the local unit 102. Moreover, the videoconferencing system 100 may include more than 2 units. Several units may participate in the videoconferencing system 100 and may be connected, for example, through the network 110.

Unlike conventional video conferencing systems, a local user Y of the videoconferencing system 100 may provide input into the local unit 102 to exert control over components of the remote unit 104. Input from the local user Y may include commands to move or change the viewing angle of the remote camera 114, commands for the remote camera 114 to zoom in or out, and/or the selection of a focus point. In embodiments where the remote unit 104 comprises multiple cameras, the input from the local user Y may include the selection of different cameras. Where multiple participants to a videoconference are attempting to exert control over the remote unit 104, the videoconferencing system 100 may utilize a priority system to determine which participant may actually exert control over the remote unit 104, as will be described in greater detail below.

A local user Y may wish to manually move or zoom the remote camera 114 by entering input into the local unit 102, through, for example, controls 116a. For example, the local user Y may wish to focus on a specific region within the viewing area of the remote camera 114. The local user Y may select arrow keys with a mouse click, for example, on the local unit 102 commanding the remote camera 114 of the remote device 104 to move or otherwise change its viewing angle to better view the area of interest to the local user Y. Manual user input may also command the remote camera 114 to zoom into a specific region of its viewing area that is of interest to the local user Y. For example, the local user Y may be participating in a videoconference with the remote user X. The remote user X may be holding an object in her hand that is the subject of conversation or otherwise of interest to the local user Y. Therefore, the local user Y may provide input to the local unit 102, through, for example, controls 116a, instructing the remote camera 114 to move in a particular direction to center the object in the viewing area and/or zoom the remote camera 114 in on the object of interest to acquire a better view of the object.

A local user may also exert automatic control over the remote camera 114 from the local unit 102 by selecting a focus point within a viewing area of the remote camera 114. A focus point may be an object, a person, a region, or any part of an object, person, or region within the remote camera's 114 viewing area that is of interest a user. The focus point may be a particular person, or part of a person, such as the remote user's face, an object the remote user may be holding, or any other object within the viewing area of the remote camera 114. For example, the subject of a videoconference may be a particular object within the viewing area of a remote camera 114. A local user may select that object as the focus point. While the focus point may be a particular object or person, it may also be any other region of interest in the remote camera's 114 viewing area. The focus point may include the region selected by the user and a boundary of any reasonably suitable radius or distance around the chosen focus point. For example, the local user Y may select a single point and the focus point may be a predetermined radius around that point with the chosen point as the center of the focus point. The boundaries of the focus point may also be chosen more precisely by the local user Y, by, for example, the local user Y specifically defining the boundaries of the focus point by defining a circle, square, or other geometric shape to define the focus point.

Focus points may also be set or pre-set into a local unit 102. For example, a pre-set focus point setting may include an automatic predetermined diameter around the chosen focus point, such that when the local user Y selects a focus point, the remote camera 114 automatically moves and zooms into the predetermined diameter around the chosen focus point. Focus point settings may be any reasonably suitable region set by a user or pre-set into the local unit 102. Selected focus points may also be stored at a local unit 102. For example, if a local user Y selects a particular remote user X as the focus point, that selected focus point may be stored as a file at the local unit 102. Therefore, the local user Y may chose the stored focus point at a later videoconferencing session, such that the remote unit 104 automatically considers the stored remote user X as the focus point.

In response to the selection of a focus point from the local user Y, the local unit 102 may transmit the desired focus point through the network 110 to the remote unit 104. When the remote unit 104 receives the selected focus point, the remote unit 104 may respond automatically by locking onto the focus point. Locking onto the focus point means the remote camera 114 may alter its viewing angle to put the chosen focus point in a prominent region of the remote camera's 114 viewing area, recognize the chosen focus point, and automatically track any movement of the chosen focus point such that the focus point will remain in a prominent position within the viewing area of the remote camera 114. A prominent position in the viewing area of the remote camera 114 may be the center, or near the center, of the viewing area of the remote camera 114. If the chosen focus point is not in the center of the viewing area of the remote camera 114 when selected by the local user Y, the remote camera may move, with the assistance of the camera moving system 118b, to center the focus point in its viewing area. Locking onto the focus point may also involve zooming by the remote camera 114 to provide the local user Y with a closer view of the focus point. The remote camera 114 may zoom in conjunction with the movement of the remote camera 114 by the camera moving system 118 or the remote camera 114 may zoom independently of the camera moving system 118.

Locking onto a focus point may also include optimizing the images captured by the remote camera 114. Optimizing the images captured by the remote camera means that the images captured by the remote camera 114 may be modified or enhanced. Images may be modified by cropping the images viewed by the remote camera 114, such that only images of a focus point, for example, are transmitted to the local unit 102. That is, the remote camera 114 may lock onto a selected focus point by cropping or filtering out parts of the images surrounding the focus point thereby transmitting more prominent images of the focus point. Locking onto a focus point may also involve optimizing images by enhancing the images captured by the remote camera 114. For example, in response to a local user Y selecting a focus point, the remote camera 114 may digitally enhance the region of its viewing area selected as the focus point. Such digital enhancement techniques may be performed by methods known in the art.

After locking onto the focus point in accordance with the input received from the local unit 102, the remote unit 104 may transmit the images captured by the remote camera 114 back through the network 110 for display on the local unit 102. The transmitted images will include images of the selected focus point and may also include optimized images of the selected focus point.

The local user Y may provide input into the local unit 102 to select a focus point by any reasonably suitable manner. For example, the controls 116a of the local unit 102 may provide interactive tools, as described above, allowing the local user Y to select a focus point. The local unit 102 may also accept input in other areas of the local unit 102. For example, the local unit 102 may utilize touch-screen technology so that a local user Y may directly touch the remote user display 106a to select a focus point. The local unit 102 may also respond to voice commands from the local user Y so that the local user Y may audibly select a focus point.

In some circumstances, a remote user X may not desire for a local user Y to have full control over the remote camera 114 of the remote unit 104. Therefore, restrictions may be placed on a local user Y's ability to select a focus point or control the remote camera 114 of the remote unit 104. For example, a remote user X may not desire for a local user Y to have the ability to follow his movements, because the remote user X may wish to stay off-camera or keep a certain object or portion of the viewing area off-camera. In this case, the remote user X may limit or terminate the local user Y's ability to control the remote camera 114 by providing input into the remote unit 104, through, for example, controls 116b, indicating the remote user X' desire to terminate or limit the local user Y's control.

In other examples, a videoconference may include multiple participants and multiple devices having the capability to transmit user input to the remote unit 104, each attempting to exert control over the remote unit 104. In these circumstances, conflicting attempts to control the remote unit 104 may be received by the remote unit 104. For example, a participant to the videoconference may attempt to pan the remote camera 114 of the remote unit 104 to the right, while another participant may attempt to move the remote camera 114 to the left at the same time. When conflicting input is received, the remote user X may determine which received input will be permitted to exert control over the remote unit 104. The determination may be made individually, with respect to each input received at the remote unit 104. For example, every, request to control the remote unit 104 may be presented to the remote user X who may then determine which request will be granted.

Alternatively, the videoconferencing system 100 may utilize a priority or ranking system to determine which device will be permitted to control the remote unit 104 when conflicting control requests are made. For example, he videoconference may occur within a preestablished hierarchy. During a corporate videoconference, for instance, between the president, vice president, chief financial officer, etc of a corporation the videoconferencing system 100 may be configured to allow input received from the president of the corporation to automatically override all other input attempting to control the remote unit 104. Similarly input from the vice president may have priority over all other members of the corporation except for the president The priority or ranking system may be established and altered by the remote user X or any other entity based on any criteria

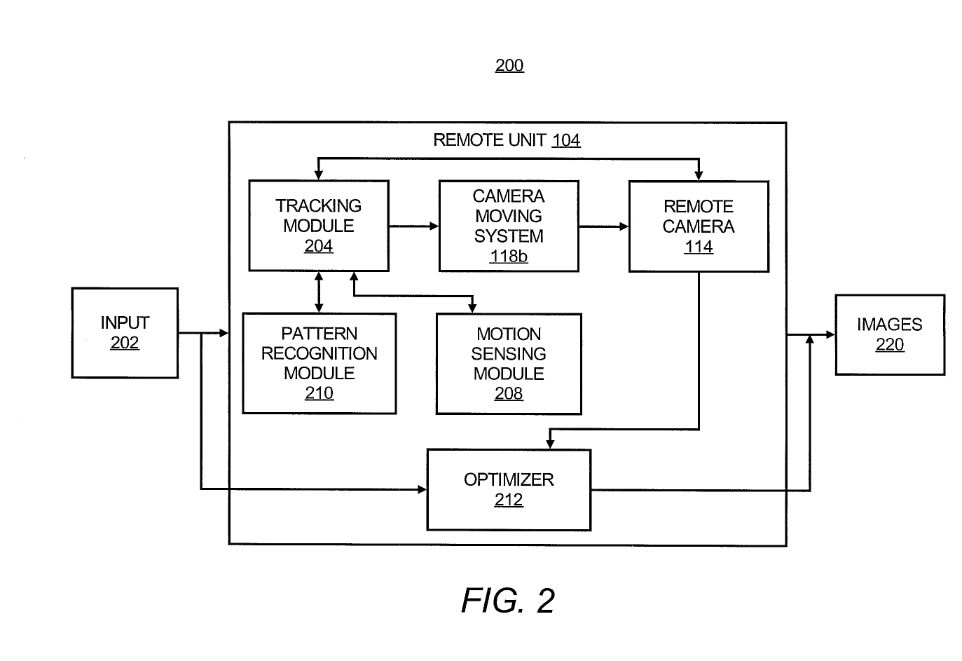

FIG. 2 depicts an illustrative block diagram of a system 200 in which the remote unit 104 may operate. The remote unit 104 depicted in FIG. 2 is merely an example of some of the elements that may be included in the remote unit 104. The remote unit 104 may lack some of the elements depicted in FIG. 2 or may include other elements not depicted in FIG. 2. Similarly, the remote unit 104 depicted in FIG. 2 may comprise the same or different components as the local unit 102.

The system 200 includes input 202 received into the remote unit 104. The input 202 may be received through a network interface of the remote unit 104 from the local unit 102 transmitted through the network 110 and may include the selection of a focus point. The input 202 may be received by a tracking module 204, which may comprise hardware, software, or a combination thereof, allowing the tracking module 204 to instruct the remote camera 114 to lock onto the focus point. The tracking module may also instruct the camera moving system 118b to change the viewing angle of the remote camera 114 to allow the remote camera 114 to lock onto the focus point. The tracking module 204 may also receive feedback from the remote camera 114 so that the tracking module 204 may verify that it is tracking the correct focus point.

The remote unit 104 includes a motion sensing module 208 and a pattern recognition module 210, both of which may provide input into the tracking module 204. Both modules may comprise hardware, software, or a combination thereof and may be an integrated part of the remote camera 114 or may be separate and distinct components connected to the remote camera 114 through the remote unit 200.

The pattern recognition module 210 may analyze the selected focus point viewed by the remote camera 114 and may store the analyzed focus point as a recognizable pattern. The pattern recognition module 210 may determine and instruct the tracking module 204 when the pattern changes and may recognize the same pattern after it has changed. As a result, the tracking module 204 may determine that a pattern has moved and may recognize the pattern in a different location. For instance, a local user Y may provide input to the local unit 102 indicating that a remote user X' face is the focus point. In response to the receipt of the selected focus point, the remote camera 200 may lock onto the remote user X' face. The remote user X' face may be analyzed by the pattern recognition module 210 and stored as a recognizable pattern.

The pattern recognition module 210 may also save the patterns of selected focus points, so that they may be recalled later. For example, if a local user Y selects a remote user's X face as a focus point during a videoconference, the pattern recognition module 210 may analyze and store the remote user X' facial profile. This focus point may be stored on the local unit 102 and saved after the videoconference ends. Therefore, when a new videoconference begins, instead of the local user Y having to re-select the remote user X' face as the focus point, the local user Y need only instruct the remote unit 104 to look for the remote user X' face selected during the previous videoconference. The pattern recognition module 210 may save a series of selected focus points.

Once locked onto a focus point, the remote camera 114 may automatically track the movements of the focus point with the aid of the motion sensing module 208. The motion sensing module 208 may include motion sensors and software for determining direction and/or distance of motion. For example, when locked onto the remote user X' face, the remote user X may stand up or move around. The motion sensing module 208 may sense this motion and may estimate or determine the direction the remote user X moved and how far the remote user X moved. The tracking module 204 may instruct the camera moving system 118b or the remote camera 114 directly to change its viewing angle to track the face of the remote user X. When the remote camera 114 moves to a new viewing angle, the pattern recognition module 210 may analyze the new viewing area to verify that the remote camera 114 is tracking the correct focus point. The tracking module 204 may compare current patterns in the new field of view of the remote camera 114 to the patterns stored when the pattern recognition module 210 initially locked onto and analyzed the focus point. In this manner, the motion sensing module 208 and the pattern recognition module 210 may work in concert to assure that the tracking module 204 is quickly, accurately, and automatically tracking the selected focus point.

The remote unit 104 may transmit or otherwise output the images 220 captured by the remote camera 114. The images may be transmitted through the network interface of the remote unit 104 to the network 110 for transmission back to a local unit 102. The images 220 may include images of the tracked focus point, which may be displayed on the remote user display 106a of a local unit 102.

In some examples, the remote unit 104 may also include an optimizer 212. The optimizer 220 may receive input, including the selected focus point, and may optimize the images captured by the remote camera 114 by modification or enhancement, as described above. For example, the optimizer 220 may crop or filter out parts of the image surrounding the focus point or may digitally enhance the focus point. The optimizer may also optimize the images tracked by the tracking module 204 and output the optimized images 220.

Once locked on to a focus point, the remote camera 114 may remain locked onto that focus point until receiving another command, such as input from the local user Y, indicating the selection of another focus point, de-selection of the focus point, or a command from the remote user X terminating or limiting local user Y's control over the remote camera 114. Other circumstances may also unlock or interrupt the tracking of a focus point. For example, the selected focus point may move out of the maximum viewing area of the remote camera 114. When a focus point leaves the maximum viewing area of the remote camera 114, the local user de-selects the focus point, or a remote user X terminates or limits control over the remote camera, the remote camera may return to a standard viewing angle or window or the viewing angle or window captured before a focus point was selected.

The remote unit 200 may also include an audio device (not illustrated). The audio device may capture and transmit audio data associated with the images captured by the remote camera 114 and may also provide the remote unit 200 with the ability to allow a remote user X and a local user Y to communicate orally.

The remote unit 200 may be capable of receiving continuous user input from the local unit 102. The continuous user input may include the selection of new focus points. When the remote unit 104 receives the selection of a new focus point, the remote camera 112 may unlock or disengage from the previous focus point and lock onto the new focus point. The remote camera 114 may then zoom into and track the new focus point. In this manner, the remote unit 200 may simulate a natural face-to-face conversation for a local user Y, because a local user Y may quickly alter his focus point to view different regions of the viewing area as if he were having a natural conversation. The input 202 may also include limitations and restrictions on the control that a user may exert over another users camera. The input 202 may be entered by a user through, for example, controls 116a and 116b.

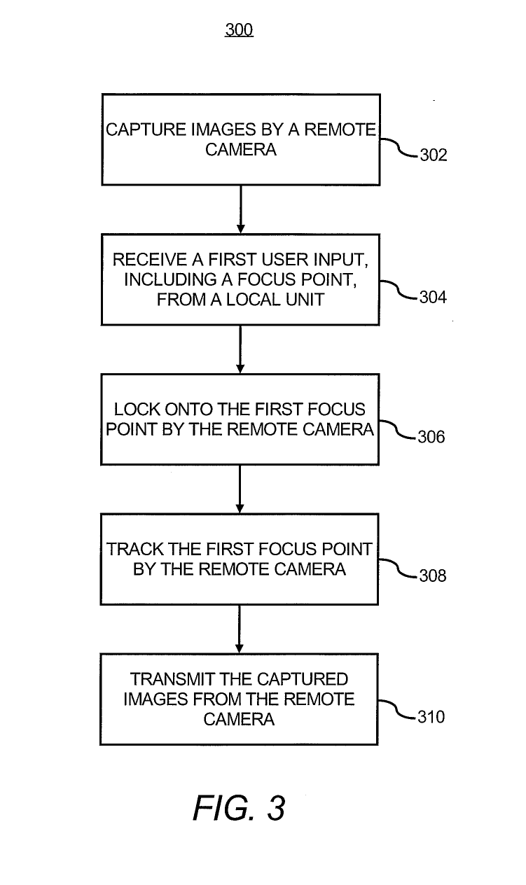

FIG. 3 depicts an illustrative flow chart of a method 300 for automatically tracking a focus point by a remote camera 114. The method 300 is described with respect to FIGS. 1-2 by way of example and not limitation and it will be apparent that the method 300 may be used in other systems.

At step 302, a remote camera 114 of a remote unit 104 may capture images. At step 304, the remote unit 104 may receive input. The input may include the selection of a focus point and it may be received through a network interface via a network. At step 306, the remote camera 114 may lock onto the selected focus point. Locking onto the selected focus point may include movement by the remote camera 114 to acquire a more prominent view of the focus point by centering the focus point in the viewing area and/or zooming by the remote camera 114 to capture closer images of the focus point. At step 308, the remote camera 114 may track any movement of the focus point. Tracking may be performed by a tracking module 204 and may be assisted by a pattern recognition module 210 and/or a motion sensing module 208. The tracking module 204 may instruct the camera moving system 118b to move the remote camera 114 to track movement of the focus point. At step 310, the remote unit 104 may transmit the captured images of the focus point. The remote unit 104 may transmit the captured images through a network interface via a network to the local unit 102.

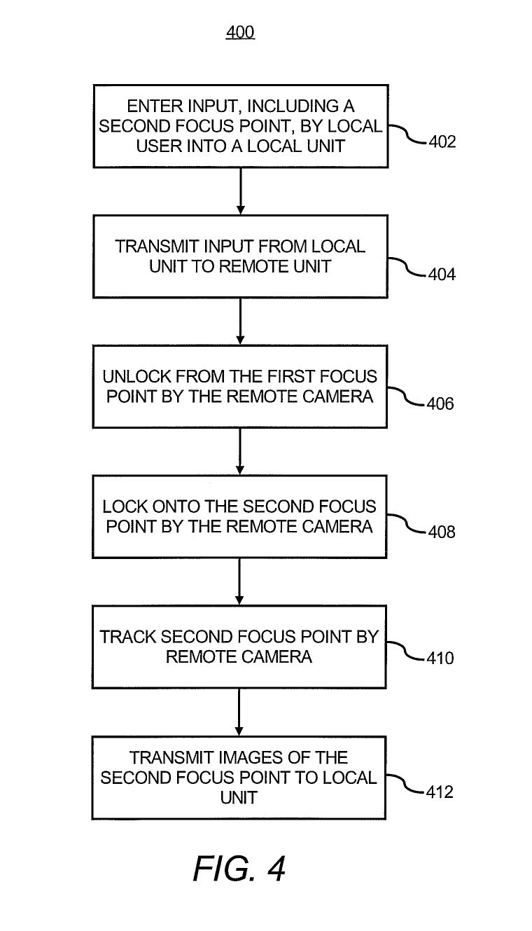

FIG. 4 depicts an illustrative flow chart of a method 400 for locking onto a second focus point by a remote camera 114. The method 400 is described with respect to FIGS. 1-2 by way of example and not limitation and it will be apparent that the method 400 may be used in other systems.

At step 402, a local user Y may enter input into the local unit 102, where the input includes the selection of a second focus point. The local user Y may enter input in any reasonably suitable manner, several of which are described above. At step 404, the local unit 102 may transmit the input from the local unit 102 to the remote unit 104. The local and remote units may be in different physical locations and the input may be transmitted via a network. At step 406, the remote unit 104 may unlock from the first focus point in response to receipt of the input comprising the selection of the second focus point. At step 408, the remote camera 114 may lock onto the second focus point. Locking onto the second focus point may include any of the processes described above including, moving, zooming, and optimizing the captured images and may be assisted by the pattern recognition module 210. At step 410, the remote camera 114 may track the second focus point in the manner described above, including moving, zooming, and optimizing and may be assisted by the tracking module 204, the pattern recognition module 210, the camera moving system 118b, the motion sensing module 208, and the optimizer 212. At step 412, the remote unit 104 may transmit the images of the second focus point to the local unit 102 via the network 110.

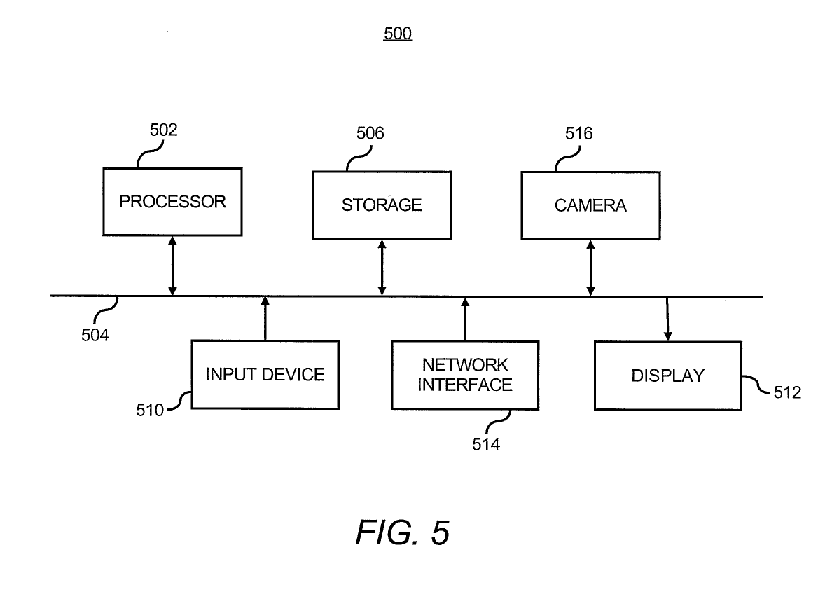

FIG. 5 depics an illustrative block diagram of a general purpose computer system 500 that is operable to be used as a platform for the systems described above. The system 500 may be used as, or may comprise a part of the local unit 102 or the remote unit 104. It will be apparent to one of ordinary skill in the art that a more sophisticated computer system is operable to be used. Furthermore, components can be added or removed from the computer system 500 to provide the desired functionality.

The computer system 500 includes processor 502, providing an execution platform for executing software. Commands and data from the processor 502 are communicated over a communication bus 504. The computer system 500 also includes a main memory 506, such as a Random Access Memory (RAM), where software is resident during runtime, and a secondary memory 508. The secondary memory 508 includes, for example, a hard disk drive and/or a removable storage drive representing a floppy diskette drive, a magnetic tape drive, a compact disk drive, etc., or a nonvolatile memory where a copy of the software is stored. In one example, the secondary memory 508 also includes ROM (read only memory), EPROM (erasable, programmable ROM), EEPROM (electrically erasable, programmable ROM). The computer system 500 includes a display 514 and user interfaces comprising one or more input devices 512, such as a keyboard, a mouse, a stylus, and the like. However, the input devices 512 and the display 514 are optional as well as other shown components. A network interface 510 is provided for communicating with other computer systems. The network interface 510 may be present in both the local unit 102 and the remote unit 104 and may facilitate connection to a network 110 to allow the local and remote units to communicate with each other. For example, the local unit 102 may connect to a network 110 through a network interface 510 to transmit input, such as a selected focus point, through the network to the remote unit 104. Similarly, the remote unit 104 may connect to a network 110 through a network interface 510 to receive input from the local unit 102 and to transmit images to the local unit 102. The computer system 500 may also include a camera 516. The camera 516 may be the local camera 112, the remote camera 114, or any component of the local or remote unit 102, 104.

One or more of the steps described herein are operable to be implemented as software stored on a computer readable medium, such as the memory 506 and/or 508, and executed on the computer system 500, for example, by the processor 502.

The steps are operable to be embodied by a computer program, which can exist in a variety of forms both active and inactive. For example, they exist as software program(s) comprised of program instructions in source code, object code, executable code or other formats for performing some of the steps. Any of the above can be embodied on a computer readable medium, which include storage devices and signals, in compressed or uncompressed form. Examples of suitable computer readable storage devices include conventional computer system RAM (random access memory), ROM (read only memory), EPROM (erasable, programmable ROM), EEPROM (electrically erasable, programmable ROM), and magnetic or optical disks or tapes. Examples of computer readable signals, whether modulated using a carrier or not, are signals that a computer system running the computer program may be configured to access, including signals downloaded through the Internet or other networks. Concrete examples of the foregoing include distribution of the programs on a CD ROM or via Internet download. In a sense, the Internet itself, as an abstract entity, is a computer readable medium. The same is true of computer networks in general. It is therefore to be understood that those functions enumerated below may be performed by any electronic device capable of executing the above-described functions.

While the embodiments have been described with reference to examples, those skilled in the art will be able to make various modifications to the described embodiments without departing from the true spirit and scope. The terms and descriptions used herein are set forth by way of illustration only and are not meant as limitations. In particular, although the methods have been described by examples, steps of the methods may be performed in different orders than illustrated or simultaneously. Those skilled in the art will recognize that these and other variations are possible within the spirit and scope as defined in the following claims and their equivalents.

What is claimed is:

1. A method of capturing images including a focus point at a remote unit based on input from a local unit identifying the focus point, the method comprising:
capturing images by a remote camera of the remote unit;
receiving a first user input from the local unit, wherein the first user input includes the selection of a first focus point;
locking onto the first focus point by the remote camera by using the received first user input;
automatically tracking movement of the first focus point by the remote camera; and
transmitting the captured images from the remote camera, wherein the captured images include images of the first focus point.

2. The method of claim 1, wherein locking onto the first focus point further comprises zooming in on the first focus point by the remote camera.

3. The method of claim 1, wherein locking onto the first focus point further comprises analyzing the first focus point with a pattern recognition module.

4. The method of claim 1, wherein automatically tracking movement of the first focus point further comprises
moving the remote camera.

5. The method of claim 4, wherein automatically tracking movement of the first focus point further comprises
automatically zooming in or out of the first focus point by the remote camera as the first focus point moves toward or away from the remote camera.

6. The method of claim 1, further comprising:
receiving a second user input by the network interface of the remote unit, wherein the second user input includes the selection of a second focus point different from the first focus point;
unlocking from the first focus point by the remote camera;
locking onto the second focus point by the remote camera; and
automatically tracking movement of the first focus point by the remote camera; and
transmitting images from the remote camera to the local unit, wherein the images include images of the second focus point.

7. The method of claim 1, wherein transmitting the captured images from the remote camera further comprises
transmitting the captured images to the local unit.

8. The method of claim 1 further comprising:
entering input by a user into a local unit, wherein the input includes the selection of a focus point; and
transmitting the input from the local unit to the remote unit.

9. The method of claim 1, wherein receiving a first user input from the local unit further comprises:
receiving a first user input from the local unit via a network, and wherein the remote unit and the local unit are in a different physical locations.

10. A remote unit operable to capture images including a focus point identified based on input received from a local unit, the remote unit comprising:
a remote camera for capturing images;
a tracking module for automatically tracking the focus point; and
a network interface for receiving input from the local unit and transmitting the captured images, wherein the input includes the selection of a focus point and wherein the transmitted images include images including the focus point.

11. The remote unit of claim 10, wherein the remote unit is operable to receive images captured at the local unit via the network interface, the remote unit further comprising:
a remote user display for displaying the images received from the local unit.

12. The remote unit of claim 11, wherein the remote camera further comprises:
a camera moving system to move the remote camera to track the focus point.

13. The remote unit of claim 11, wherein the remote camera further comprises:
a camera lens operable to zoom in and out on a focus point.

14. The remote unit of claim 11, wherein the remote camera further comprises:
a pattern recognition module for locking onto the focus point.

15. The remote unit of claim 11, wherein the remote camera further comprises:
a motion sensing module for sensing motion of the focus point.

16. The remote unit of claim 11, wherein the remote camera further comprises:
an optimizer for at least one of modifying or enhancing images of the focus point.

17. A computer readable storage medium on which is embedded one or more computer programs comprising a set of instructions that when executed by a processing circuit perform a method comprising:
capturing images by a remote camera of a remote unit;
receiving a first user input by the remote unit, wherein the first user input includes the selection of a first focus point;
analyzing the first focus point with a pattern recognition module;
automatically tracking movement of the first focus point by the remote camera; and
transmitting the captured images from the remote camera, wherein the captured images include images of the first focus point.

18. The computer readable storage medium according to claim 17, said one or more computer programs further comprising a set of instructions for:
moving the remote camera to track movement of the first focus point.

19. The computer readable storage medium according to claim 17, said one or more computer programs further comprising a set of instructions for:
zooming in by the remote camera to capture a more prominent view of the first focus point.

20. The computer readable storage medium according to claim 17, said one or more computer programs further comprising a set of instructions for:
receiving a first user input from the local unit via a network, and wherein the remote unit and the local unit are in different physical locations.
